(19) United States
(12) Patent Application Publication
(10) Pub. No.: US 2007/0055932 A1
(43) Pub. Date: Mar. 8, 2007

(54) Application programming interfaces for graphical user interfaces

(75) Inventors: Christopher A. Glein, Seattle, WA (US); David Ethan Zoller, Seattle, WA (US); David R. Fulmer, Redmond, WA (US); Francis M. Hogle, Bellevue, WA (US); John E. Elsbree, Redmond, WA (US); Mark J. Finocchio, Redmond, WA (US); Michael E. Creasy, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/320,668

(22) Filed: Dec. 30, 2005

Related U.S. Application Data
(60) Provisional application No. 60/713,401, filed on Sep. 2, 2005.

(51) Int. Cl. G06F 17/00

(52) U.S. Cl. 715/526; 715/513

(57) ABSTRACT

A method and system to generate graphical user interface via a collection of application programming interfaces are provided. The application programming interfaces utilize views and models that define the elements and values associated with the graphical user interface. The views and models may be defined in different languages, are separately alterable, and may be communicatively connected with each other when generating visuals of the elements associated with the graphical user interface. The views and models related with a primary application may be utilized by a third-party application to extend the graphical user interface of the primary application.

### CROSS-REFERENCE TO RELATED APPLICATION

This application claims a benefit under 35 U.S.C. 119(e) of U.S. Provisional Application No. 60/713,401, entitled “Application Program Interfaces for a User Interface” and filed Sep. 2, 2005.

### STATEMENT REGARDING FEDERALLY SPONSORED RESEARCH OR DEVELOPMENT

Not applicable.

### BACKGROUND

Currently, graphical user interfaces are developed based on compromises between developers and designers. The developers write code associated with data interactions and transformation, and designers write code associated with display and layout of elements or data on the graphical user interface. The designers and developers communicate frequently about the visual aspects of the graphical user interface because the underlying data may drastically affect the layout of elements on the graphical user interface. The delays associated with the communications between designers and developers may increase the cost associated with generating the graphical user interface of an application. Furthermore, the graphical user interface for the applications designed utilizing conventional methods are not reusable by remote applications that communicate with the applications. The remote applications may have to utilize an independent set of code to generate appropriate graphical user interfaces, which may introduced inconsistencies in the layout, color or feel of the applications.

### SUMMARY

In an embodiment, a method to generate graphical user interfaces via a collection of application-programming interfaces is provided. Declarative descriptions define a collection of elements utilized by the graphical user interfaces. The declarative descriptions are parsed to detect rules associated with the elements. Visuals of the elements are generated by a renderer based on rules and parameters associated with the elements.

In another embodiment, the renderer communicates with the application-programming interfaces to generate the visuals associated with the elements. The application-programming interfaces include views and models that define the elements in distinct languages. The views and models are communicatively connected to allow the graphical user interfaces to properly represent layouts and data associated with applications utilizing the application-programming interfaces.

In another embodiment, secondary applications utilize the application-programming interfaces to extend the graphical user interfaces associated with a primary application. The secondary application may utilize the views and models of the primary application as a base to create complex graphical user interfaces having the look and feel of the primary application. The complex graphical user interfaces may be navigated by utilizing controls associated with the primary application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a network diagram that illustrates an exemplary computing environment, according to embodiments of the invention;

FIG. 2 is a component diagram that illustrates an application-programming interface, according to embodiments of the invention;

FIG. 3 is a code diagram that illustrates the languages utilized by the application-programming interface, according to an embodiment of the invention;

FIG. 4 is a logic diagram that illustrates the interactions between an application and an add-in, according to embodiments of the invention;

FIG. 5 is a logic diagram that illustrates the interactions between an application and an add-in, according to an embodiment of the invention; and

FIG. 6 is a logic diagram that illustrates a method of generating graphical user interfaces, according to an embodiment of the invention.

### DETAILED DESCRIPTION

Embodiments of the invention generate graphical user interfaces based on a collection of application-programming interfaces that separately control the layout and data associated with the graphical user interfaces. The layout of the graphical user interface may declaratively define elements used to generate visuals associated with the graphical user interface. The data of the graphical user interface may be defined by an imperative language. The declarative description is parsed to detect rules that are utilized to manipulate the elements of the graphical user interface. Moreover, third-party applications may utilize the application-programming interfaces to generate graphical user interfaces that have the “look and feel” of a primary application.

A computer system that generates graphical user interfaces includes a collection of application-programming interfaces, a renderer, a primary application and third-party applications. The computer system may utilize the application-programming interfaces to communicate between the renderer and the primary and third-party applications. The renderer may receive instructions that control the layout of the elements of the graphical user interface. The renderer may be a processor that executes the instructions to display the elements on a display device, such as, a liquid-crystal or plasma displays. In an embodiment of the invention, the computer system may be communicatively connected to client devices through a communication network, and the client devices may include a portable device, such as, laptops, personal digital assistants, smart phones, etc.

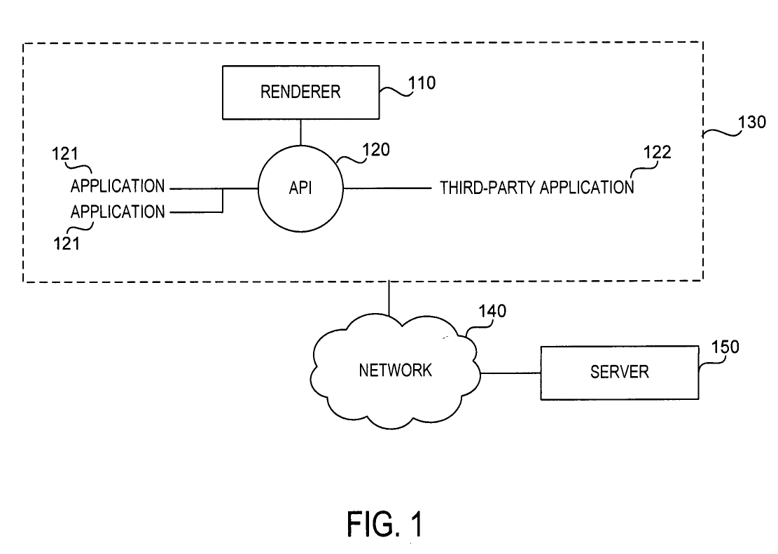

FIG. 1 is network diagram that illustrates an exemplary computing environment 100, according to embodiments of the invention. The computing environment 100 is not intended to suggest any limitation as to scope or functionality.

Embodiments of the invention are operable with numerous other special purpose computing environments or configurations. With reference to FIG. 1, the computing environment 100 includes a client device 130, server device 150 and a communication network 140.

The client device 130 includes processing units coupled to a variety of input devices and computer-readable media via communication buses. The computer-readable media may include computer storage and communication media that are removable or non-removable and volatile or non-volatile. By way of example, and not limitation, computer storage media includes electronic storage devices, optical storages devices, magnetic storage devices, or any medium used to store information that can be accessed by client device 130 and communication media may include wired and wireless media. The input devices may include remote controls, mice, keyboards, joysticks, controllers, microphones, cameras, camcorders, or any suitable device for providing user input to the client device 130.

In an embodiment of the invention, the client device 130 includes a renderer 110, an application-programming interface (API) 120, primary applications 121 and third-party applications 122. The renderer 110 provides the visual representation of elements of a graphical user interface. The renderer 110 is connected with the API 120 to allow graphical user interfaces associated with applications 121-122 to be displayed on a display device. The API 121 is a collection of transforms that manipulate the state of the graphical user interface associated with the applications 121-122. The API 121 allows the applications to render multimedia content, such as, text, images, video, or audio. The applications 121-122 may include players that reproduce multimedia content and editors that create the multimedia content. In an embodiment of the invention, the applications may include third-party applications 122, such as, remote or add-in applications that increase the functionality associated with a primary application 121. The renderer 110 utilizes the API 120 to coordinate concurrent communication and display of graphical user interfaces associated with the applications 121-122. The third-party application 122 may be stored locally on the client device 130 or remotely on the server device 150. The API 120 may support remote access to third-party applications located on the communication network 140.

Additionally, the communication network 140 may be a local area network, a wide area network, satellite network, wireless network or the Internet. The client device 130 may include laptops, smart phones, personal digital assistants, or desktop computers. The client device 130 may utilize the communication network 140 to communicate with the server 150. The computing environment 100 illustrated in FIG. 1 is exemplary and other configurations are within the scope of the invention.

In an embodiment of the invention, the application-programming interfaces (APIs) operate in an environment where the description of objects is handled separately from display of objects in a graphical user interface. This is accomplished by describing an object as a model while handling the display of the object using a separate view description. The model description may be utilized as parameters in the view description. Since a model is not associated with the display functions of the graphical user interface, multiple views may be associated with the model to enable dynamic graphical user interface transitions.

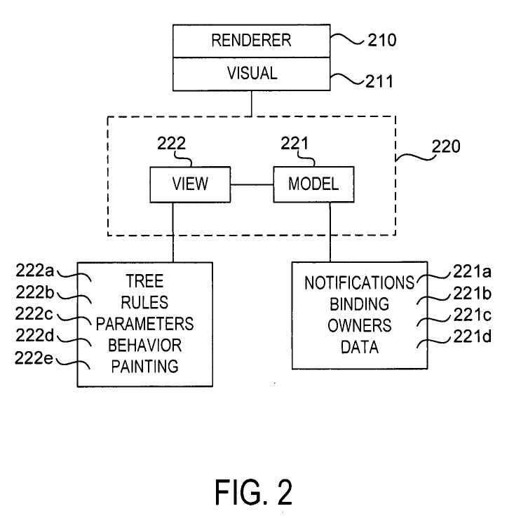

FIG. 2 is a component diagram that illustrates an application-programming interface (API) 220, according to embodiments of the invention. The API 220 comprises a model 221 and a view 222. The model 221 and view 222 are separate descriptions that define the layout and data associated with a graphical user interface. The applications may utilize the API 220 to communicate with a renderer 210. The renderer 210 creates a visual 211 for each visible element described in the view 222 related with a graphical user interface. Preferably, multiple visuals 211 can be created for a give view 222. In an embodiment of the invention, the graphical user interface may be associated with third-party applications that utilize the views 222 associated with a primary application as a base for creating complex graphical user interfaces.

In certain embodiments, renderer 210 may map a visual 211 to each view 222 defined for a graphical user interface. The visual 211 is a visible, graphical representation of the views 222. In an embodiment, each view 22 may be associated with a visibility attribute that indicates whether a graphical visual 211 is required for the view 222. In some embodiment, views that are not contained in the display area associated with the renderer 210 are not reproduced on the display device. The renderer 210 may communicate with the applications through the API 220 to receive scene descriptions and control display timing associated with the visuals 211. The renderer 210 may perform focus and layer management when determining which visuals 211 to display on the display device. The focus and layer management may be accomplished via focus and layer ranks associated with the each visual 211. In an embodiment, the timing requirements for multimedia content, such as movies, and real-time broadcasts may be implemented by a Direct X driver. In an embodiment, when the graphical user interface depicts an animate scene, the visuals 211 may be organized in tree having a one-to-one correspondence with a view tree 222a to create an animated sequence of visuals 211. In certain embodiments of the invention, the view 222 may include a hide-during-animation property that indicates when to hide a visual 211 associated with the view 222. The hidden visuals are stored in an orphan collection, and may be disposed of when the animation sequence is complete. Moreover, the renderer 210 may orchestrate the concurrent rendering of graphical user interfaces associated with a primary application and a third-party application.

In an embodiment, model 221 provides the logic behind the graphical user interfaces generated by the views 222. A collection of the models 221 may be exposed to allow developers to generate the graphical user interfaces associated with an application. The models 221 may provide services that enable the communications between the view 222 and the model 221. The services may include property-change notifications 221a, bindings 221b, lifetime management 221c, and dynamic data 221d. The property-change notification service 221a allows external objects, such as view 222, to listen to changes to the model 221. In an embodiment, a description associated with the model 221 may utilize a notification function to alert external objects of the changes associated with the model 221. The binding service 221b connects properties associated with a model 221 with properties of an external object, such as a model 221 or view 222. The model 221 may utilize one-way or two-way binds to connect the properties associated with the models 221. The binding service 221b propagates property changes associated with a model 221 to the associated model 221 or view 222. The one-way bind specifies a single direction in which the property changes propagate, while the two-bind allows changes to propagate in both directions. In an embodiment, the one-way bind may propagate changes in a forward or reverse direction. For instance, when a first property is connected via a one-way bind with a second property, a change to the first property may be propagated to the second property. But a change in the second property would not be propagated to the first property. However, when the first property is connected via a two-way bind with a second property, a change in either property is propagated to the connected property. The lifetime management service 221c of the model 221 minimizes notification errors or notification hijacking and ensures property management of the model 221. The lifetime management service 221c implements an ownership policy where each model 221 must be owned by an object, such as, a model 221 or view 222. Thus, when the owner of a model 221 is destroyed, the model 221 associated with the owner is also destroyed. Accordingly, the lifetime management service may provide efficient garbage collection of unnecessary models 221. The dynamic data service 221d allows the model 221 to allocate storage for values on an as-needed basis. For example, consider a model 221 with a property that is the same for most models. Rather than allocating a variable for each model 221, a default value may be allocated for the property, with exceptions made for models 221 having a value different from the default. Because a variable typically requires more storage space than a constant (such as a default value), if a majority of the model 221 use the default value, the overall storage requirements can be reduced. As an example, consider a Basketball Team model 221. A property of the model 221 could be number-of-players. In this example, we can assume the default value for number-of-players will be 5. However, it would still be possible to vary the number-of-players, when a team had a different number of players, such as 4. Accordingly, the services 221a-221d allow a model 221 to efficiently communicate with external objects.

In an embodiment, an application may utilize a collection of default models 221 to create new models 221 that represent the data associated with the graphical user interfaces. The default models 221 may include, but are not limited to, a command, choice, range, text and list. The command model may be used to represent an event that is invokable. On the graphical user interface, the command model may be represented by a button visual, such as, an “OK” button. The button may be utilized as a trigger for invoking an event. The choice model may be used to represent a list of options, including a currently selected option. Preferably, only one option can be selected at a time. On the graphical user interface, the choice model may be represented by a radio group, a spinner, or a check box visual. Properties for the choice model may include the options in the list, the current choice, and an index for the current choice. The value corresponding to the current choice may be exposed for manipulation. In an embodiment, the value may be incremented or decremented. The value model may be used to represent a numeric value that can have a minimum and a maximum associated with it. On the graphical user interface, the value model may be represented as a slider or a spinner visual. Similar to the choice model, the value model may be incremented and decremented. The text model may be used to represent an editable string. On the graphical user interface, the text model may be represented as an edit control box visual. The text model may define a boolean flag to indicate when an existing value may be modified. Also, the text model may generate events when a text edit is in progress or is submitted. The list model may be used to represent a list of any type of objects. On the graphical user interface, the list model may be represented as a list-box or gallery visual.

In an embodiment, a view 222 provides control of the layout, animation, painting, multimedia integration, data binding and user interactions with the graphical user interfaces. In another embodiment, the view 222 may be exposed to enable a designer to generate new views 222 having a “look and feel” associated with a base view 222. Each view 222 may own a visual (or a plurality of visuals, such as a composed set of visuals) 211 utilized by the renderer 210 to represent an element of the graphical user interface.

The view 222 may include a tree 222a, rules 222b, parameters 222c, behaviors 222d, and painting 222e. The tree 222a or collection of trees 222a may include nodes that represent each view defined for the graphical user interfaces associated with an application. Additionally, the views 222 may be defined in a markup language, such as, extensible Markup Language (XML). The markup language defining the view 222 may be parsed to generate the tree 222a. The views 222 may be associated an inheritance model that shares common characteristics that are generically defined in the view 222 with a custom view 222. Accordingly, the custom view 222 may include the common characteristics in addition to the specialized functionality. The parsed view 222 description may include rules 222b that control the state of the elements rendered on the graphical user interface. The rules 222b may define a set of conditions to match and corresponding actions to perform. Rules 222b may be arranged in prioritized groups, allowing multiple alternative states to be handled and produced. Conditions refer to a property that has changed or an event that has occurred. In another embodiment, a condition can further include one or more criteria regarding a property, such as whether a changed property value is equal to a test value. Actions represent the setting of a property, invoking a method, playing an animation, playing a sound, etc. Note that a rule 222b may be formed without having a condition. The condition for such a rule 222b is always true, so the actions in that nile 222b are always performed. Rules 222b may be given an implicit priority based on their ordering. In an embodiment, the first rule 222b may have the lowest priority and the last rule the highest. In another embodiment, the first rule 222b may have the highest priority while the last rule has the lowest. More generally, any convenient system can be used to prioritize a list of rules 222b.

In certain embodiments, the conditions of the rules 222b may determine when a change in a property occurred or when the property's value is equal to specified value. When a condition associated a rule 222b is met, the actions associated with the rule 222b may specify transformations on elements or values associated with the graphical user interface. A bind action transfers a value from a source property to a target property associated with a set of views 222. An invoke action may execute a method associated with the view 222 or model 221. A play-animation action plays an animated sequence on the graphical user interface. A play-sound action plays an audio clip associated with the view 222. A set action associates a static value with a property of the view 222. In another embodiment the rules 222b, may include specialized convenience rules 222b. The convenience rules 222b provide a collection of common condition-action combinations. The convenience rules 222b may include default-value, binding and condition. The default-value rule 222b contains a condition that is always true, and a set action. The binding rule 222b includes a change condition and a bind action. The condition rule 222b includes an equality condition and a set action. In an embodiment, transformers are utilized to convert properties having different types. For instance, a boolean transformer may convert a numerical property to a boolean, and a format transformer may convert a numerical property to a string.

In an embodiment, parameters 222c specify points of customization in the view 222. The parameters allow each view 222 to be flexible and reusable. Parameters 222c may include an identifier that is used by the view 222 to distinguish the parameters 222c associated with each view 222. Additionally, the parameters 222c may store values associated with each view 222. The values may include defaults associated with a default configuration of each view 222. In certain embodiments, parameters 222c may include models 221. The parameters 222c allow the view 222 and models 221 to communicate with each other. A view 222 may include a set of required parameters when invoking an element on the graphical user interface.

In another embodiment, behavior 222d processes instructions received from an input device. Generally, the input devices may include keyboard, mouse, or any suitable input device. The behavior 222d may modify a state associated with the view 222. The input devices allows a user to interact with the view 222 via the behavior 222d. The behavior 222d, like a model 221, may fire events that can cause the view 222 to change its appearance.

The view 222 may include painting behaviors 222e, layout behaviors, and/or other behaviors that manipulate one or more visuals 211. A layout behavior may control the position, size, margins, or padding associated with a view 222. In various embodiments, a layout behavior may describe a border, center, circle, fill, flow, graph, grid, scrolling, stage, anchor or default layout. For example, a border layout may arrange the view 222 along the edges of the viewable display area. A center layout may arrange the view 222 at the center of the viewable display area. A circle layout could arrange a view 222 in a circular region in the viewable display area. A fill layout may size a view 222 to the size of the viewable display area. A flow layout may arrange view 222 horizontally or vertically in the viewable display area. A graph layout could arrange views 222 utilizing Cartesian (x, y) coordinates to position the views 222 in a viewable display area. A grid layout arranges views 222 utilizing rows and columns in the viewable display area. A scrolling layout allows each view 222 associated with the graphical user interface to be scrolled in or out of the viewable display area. A stage layout arranges the views 222 into a primary and secondary stage that may be displayed sequentially in the viewable display area. An anchor layout can arrange views 222 based on child/parent relationships between views. For example, an anchor layout can anchor a view to an edge of a parent view, or to a specified position (such as a percentage or pixel value distance from an edge) within a parent view. More generally, an anchor layout be used to specify locations for views relative to positions for other views. If no layout is specified, a default layout can be used to specify default values for size or position associated with each view 222. Preferably, a default layout can specify a size corresponding to the size of a viewable display area associated with a view. In another embodiment, the layout behavior may create specialized animation sequences utilizing a set of views 222. The animation sequence may be displayed based on an event triggered by a layout behavior 222d. The events may include show, hide, move, size, scale, focus, change content, or idle. The show and hide events control the visibility of the animation sequence. The show event can play the animation sequence when certain visual elements are shown by layout. The hide event can play the animation sequence when visual elements are hidden by the layout. The move size and scale events can play an animation sequence when the layout behavior commits a changed position, size, or scale for the visual elements. The focus event may play an animation sequence where the input behavior receives input focus. The content change event can play an animation sequence if the visual's paint content has been modified, such as due to a text string change. The idle event can play an animation sequence when no other animation sequences are being played. The behavior 222d may be described in a markup language. In an embodiment, the layout behavior 222d may be defined in a markup language that may specify parameters that describe how the renderer should display the views 222. Common views 222 utilized by the graphical user interface may include a button, radio, edit, list or gallery. Each view 222 defines the visual aspect of a graphical element and may be linked to a model 221. For instance, the button may define a size, position, or color of the button, which may be linked to a command model 221.

In an embodiment, a view can be created using one or more view items. In such an embodiment, a view item is a primitive object that can be composed of one or more renderer visuals. For example, a list view 222 may be created by utilizing a repeater view item. A repeater can create a view item that represents each item in a list model 221. In an embodiment, the repeater creates a host item for each item in the list model 221. The repeater works intelligently with layout parameters and the list model 221 in an attempt to ask for as few items as possible, while using as few visual resources as possible. Additionally, the repeater may handle list model 221 having mixed data types. Repeater may utilize transformation on the data types to properly process the list model to create the view 222. Repeater supports notification from the models 221 to update the view 222 when the model 221 has been modified by an insertion, deletion, or move. In certain embodiments, the repeater may utilize a mapping dictionary to process the list model 221. The dictionary mapping specifies a view 222 based on the type and value associated with the list model 221. The repeater may also support infinite scrolling, where a user may continuously scroll the list model 221. When the end of the list model 221 is reached, the repeater scrolls from the beginning of the list model 221. The repeater may utilize a virtual index to create this infinite scrolling.

In an embodiment, the description of the common views 222 may be specified in a markup language that utilizes inheritance to create derived views 222 from the common views 222. The view 222 inheritance allows authors to customize some functionality while leveraging commonality across related views 222. This allows scenarios where a set of requirements is established for a pluggable view 222. Inheritance affects the view on a per-section basis. As a result, a derived view 222 may override the default content or the named content of a common view 222.

The API for the graphical user interfaces may be defined in different languages. In an embodiment the model of the API may be described in C#, while the view is described in XML. The API allows the designer and developer to separate the visual from the non-visual. The developer is able to generate the description of the non-visual aspects of the graphical user interface, while the designer generates a description of the visual aspects of the graphical user interface.

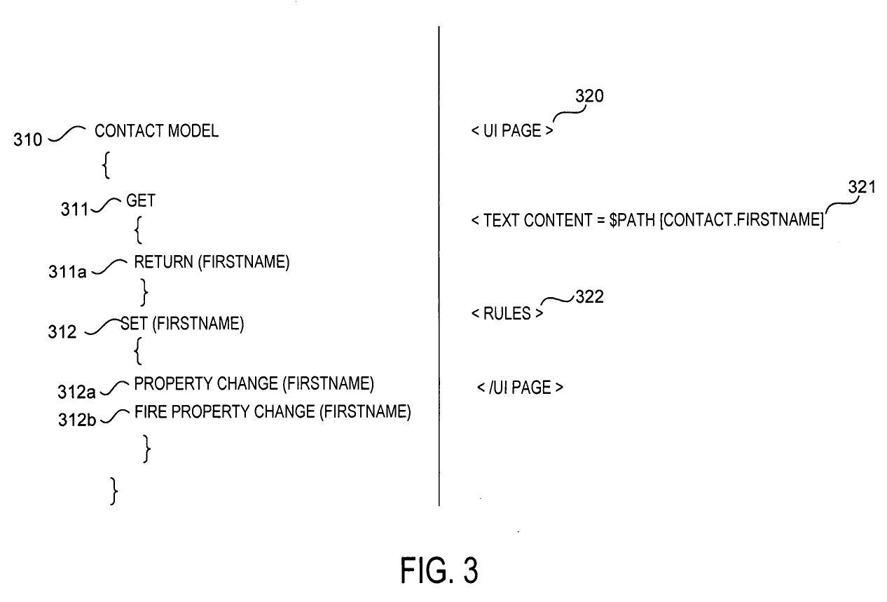

FIG. 3 is a code diagram that illustrates the languages utilized by the API, according to an embodiment of the invention. The model for a contact 310 may include a first name attribute. The contact model 310 may describe a set and get method 311 and 312, respectively. Here, the contact model 310 may be utilized to represent the first name of an instance of the contact model. The set method 312 is utilized to associate a value with the first name attribute, such as by Property Change 312a, and to notify the API when a change to the first name attribute has occurred, such as by Fire Property Change 312b. The get method 311 allows the API to request the value stored by the first name attribute. The visual aspects of the contact are described by the view's markup 320. The view's markup 320 may include a set of tags that define rules 322 and text content 321. The text content 321 may utilize the contact model 310 as a parameter to enable the view's markup 320 to manipulate the first name associated with an instance of the contact model. The text content 321 receives the first name of the instance of the contact model from the contact model 310.

The API for the graphical user interface allows a primary application to generate graphical elements based on separate descriptions of the visual and data aspects of the graphical user interface. The API may be utilized by a third-party application such as an add-in to create graphical user interfaces having the look and feel of a primary application. In an embodiment, an add-in application is a background application that is capable of launching a graphical user interface on demand. For example, add-in applications can be applications written to work with a primary application through the API. Add-ins may be launched through one or more registered entry-points. The add-in application can have one or more registered entry-points, which can be launched when primary application starts up or when a specific event is triggered from within the primary application. In an embodiment, an add-in can be launched by a user selecting the add-in from a menu, list, or by another selection method. In such an embodiment, a UI for the add-in can be presented to the user for user interaction after launch of the add-in application. In another embodiment, the add-in can be launched based on a user action that triggers another event, such as launch of another application or selecting a desired functionality from a menu. In still another embodiment, an add-in application can operate in the background waiting for events of interest to occur and launches a user interface like a toast or a dialog, or may even navigate the user to a different page, when the event occurs. In an embodiment, the primary application may be executed on a client device, while the add-in application may be executed on remote device, such as server. The add-in application may utilize the models or views associated with the API and the primary application to generate a graphical user interface for data associated with the add-in application.

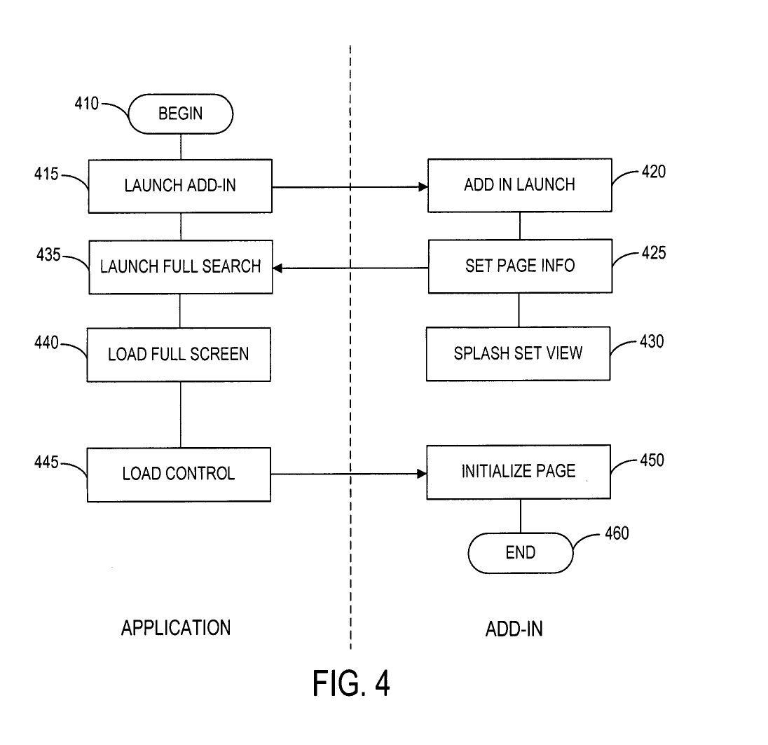

FIG. 4 is a logic diagram that illustrates the interactions between an application and an add-in, according to embodiments of the invention. The logic begins in step 410 when an application launches or a user has initiated an event that triggers the add-in. The application generates a launch add-in request, in step 410. The corresponding add-in application is launched in step 420. The add-in may transmit a response that includes a description of a view to the application, in step 425 and tracks the transmitted view, in step 430. The application parses the description of the view and generates a full-screen display of the view, in step 435. The application loads the view, in step 440, and a control that enables the navigation between the views associated with the application and the views associated with the add-in, in step 445. The page is initialized and placed in the application stack in step 450. The method ends in step 460.

The add-in may retain control by using the API to navigate the views included in a stack that includes add-in views and application views. In an embodiment, an add-in can register one or more “foreground” entrypoints, which are accessible through the different categories (e.g. “More Programs”, “Radio”, “Tasks”, etc.) When launched, a “foreground” entrypoint can indicate to the application that at least a portion of the display are is required to load the add-in's initial view. For example, the add-in could request view that includes the full screen or display area of the application, or one or more portions of the screen or display area of the application. In another embodiment, the add-in is essentially a blackbox of sorts from the perspective of the application. The add-in manages its own history, internal page navigation, input handling and rendering. As long as the user is navigating (within the add-in) from one view to another, there is no need to communicate with the application for view navigation. This provides the user with a faster navigation experience since control is centralized in the add-in, the add-in may not need to go across process boundaries to take the user to a new view, unless absolutely necessary.

In another embodiment, an add-in may be launched by setting up a remote host and creating an add-in loader that is used to load the add-in. The remote host may be a device that is remote from the application and the renderer. The renderer associated with the application may be configured to display the views received from the remote add-in.

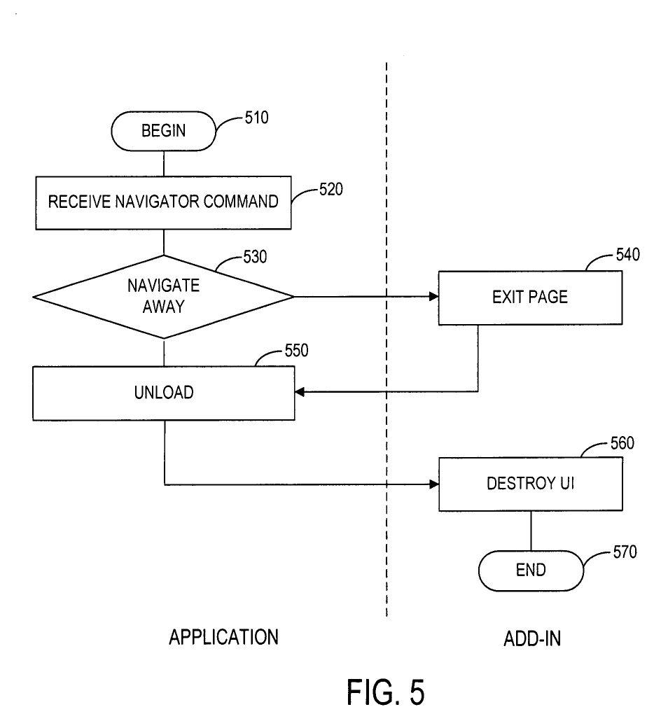

FIG. 5 is a logic diagram that illustrates the interactions between an application and an add-in, according to an embodiment of the invention. The logic begins after the add-in has been launched, in step 510. In step 520 a navigation command is received. The command is processed to determine whether the command navigates away from the add-in, in step 530. When the command navigates away, the add-in exits, in step 540. In turn, the application unloads the add-in, in step 550. In step 560, the graphical user interface associated with the add-in is destroyed. The method ends in step 570. When the command does not navigate away from the add-in, the logic waits for another navigation command.

In an embodiment, when an add-in launched, it may be executed within a primary application for part or the entire duration of its lifetime as a full-screen application. The add-in may use the API to control the page stack, navigation, etc. In some embodiments, an add-in can cease to be in the foreground, but can still exist as a background add-in waiting for some notification that can cause it to display a graphical user interface or navigate the user to a full-screen view. When the add-in is initially launched, a wrapper is created to handle communications between the add-in and the application. When the add-in view is displayed, the wrapper is stopped so that the graphical user interface has control. In an embodiment, when the add-in is inactive, but the add-in is alive control returns to the application so it can continue sending messages and keep the add-in alive. The add-in is destroyed when the application no longer sends messages to the add-in.

The API may support secondary connection with the renderer, when managing the display of the application and add-in views. A secondary-rendering session may be utilized to coordinate resource management for individual applications using the shared renderer. Secondary processes, such as, add-ins may reuse existing renderer resources like the animation, sound and graphics or device objects associated with the primary application. In another embodiment involving secondary connections, a zone in the primary application may act as a proxy for view associated with the add-in, forwarding all input that is routed to the proxy to the add-in's input queue.

In certain embodiments, raw input data and processed input may be utilized by the primary application or add-in. The raw input data may be stored in raw format and associated with the processed input data to allow the add-in to access both the raw input and processed input. Once input is tagged with its original raw data, we can forward it to the add-in, upon request. In an embodiment, a zone may generate the processed input and associations with the raw input. The zone may be a secondary-view proxy. The secondary-view proxy may leverage the zone mechanism to support multiple views in a single process.

The API may allow add-in applications and primary applications to create graphical user interfaces. The applications describe the data and graphical elements associated with the graphical user interfaces to allow a renderer to efficiently generate the graphical user interfaces.

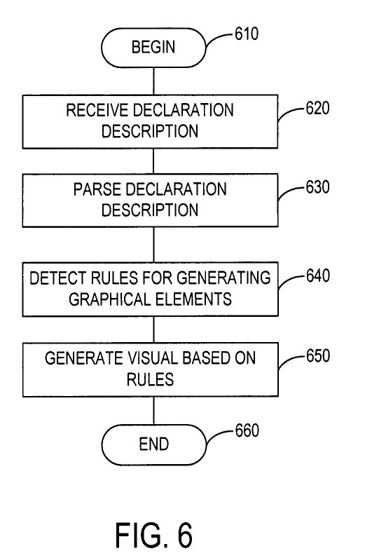

FIG. 6 is a logic diagram that illustrates a method of generating graphical user interfaces, according to an embodiment of the invention. The logic begins in step 610 when an application is launched. A declaration description of a view is received from a view loader in step 620. The declaration description is parsed, in step 630. The rules for generating the graphical elements of the view are detected in step 640. The visuals are generated for each view based on the rules, in step 650. The method ends in step 660.

In sum, the API for generating graphical user interfaces having views and models that separately describe the data and view associated with the graphical user interface. The view utilizes the model to layout the graphical elements associated with the graphical user interface. The rules associated with the view represent logic that controls the state of the graphical use interface and enable the designer to control the interaction between the user and the application.

In an alternate embodiment of the invention, third-party application, such as, add-ins, may utilize zones of a primary application to control the input processing. The zone may process the input received from the input devices and associate raw input data with the processed input data. The processed and raw input data are transmitted to the add-in to determine where or when to render a view associated with the add-in.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A computer-implemented method to generate a graphical user interface, the method comprising:
receiving a declarative description of graphical user interface elements;
parsing the declarative description to detect rules associated with the graphical user interface elements; and
generating a visual depiction of the graphical user interface elements based on the rules.

2. The computer-implemented method according to claim 1, wherein the declarative description is expressed in a markup language.

3. The computer-implemented method according to claim 1, wherein the rules define states associated with the graphical user interface elements.

4. The computer-implemented method according to claim 1, further comprising:
receiving an object-oriented description of values associated with the graphical user interface elements.

5. The computer-implemented method according to claim 4, wherein the object-oriented description binds values associated with at lease two discrete graphical user interface elements

6. A computer-implemented method to generate a graphical user interface for a secondary application, the method comprising:
receiving a declarative page from a secondary application;
parsing the declarative page to determine where graphical user interface elements should be generated; and
invoking a view having graphical user interface elements.

7. The computer-implemented method according to claim 6, wherein the declarative page is expressed in extensible Markup Language.

8. The computer-implemented method according to claim 6, further comprising:
receiving a procedural description of the values associated with the page.

9. The computer-implemented method according to claim 6, wherein the view is hosted by a primary application.

10. The computer-implemented method according to claim 6, wherein the view is scaled to meet the size requirement of the primary application.

11. The computer-implemented method according to claim 6, wherein the location of the graphical user interface is manipulated by an application-programming interface associated with the primary application.

12. The computer-implemented method according to claim 6, further comprising:
integrating the secondary application and the primary application.

13. A computer system having an application program interface for generating graphical user interfaces, the computer system comprising:
a model to represent values for elements on a graphical user interface;
a view to define the behavior of the elements included on the graphical user interface; and
a renderer to display the elements based on the model and view.

14. The computer system of claim 13, wherein the model is defined in a procedural language.

15. The computer system according to claim 13, wherein the model generates a notification when the values associated with an element changes.

16. The computer system according to claim 13, wherein the view provides animation layouts for the elements on the graphical user interface.

17. The computer system according to claim 13, wherein the view utilize rules to control the elements on the graphical user interface.

18. The computer system according to claim 13, wherein the renderer utilizes visuals to represent the element on the graphical user interface.

19. The computer system according to claim 13, wherein the elements control navigation between a primary application and a third-party application.

20. The computer system according to claim 13, wherein the view and model are separately alterable.
